(19) United States
(12) Patent Application Publication
(10) Pub. No.: US 2018/0154219 A1
(43) Pub. Date: Jun. 7, 2018

(54) MULTI-PIECE SOLID GOLF BALL

(71) Applicant: Bridgestone Sports Co., Ltd., Tokyo (JP)

(72) Inventors: Hideo WATANABE, Chichibushi (JP); Tsuyoshi NAKAJIMA, Chichibushi (JP)

(73) Assignee: Bridgestone Sports Co., Ltd., Tokyo (JP)

(21) Appl. No.: 15/804,318

(22) Filed: Nov. 6, 2017

(30) Foreign Application Priority Data
Dec. 2, 2016 (JP) 2016-235110

(51) Int. Cl. A63B 37/00; C08L 9/00; C08L 75/08; C08L 67/00

(52) U.S. Cl. CPC A63B 37/0076; C08L 2205/035; A63B 37/0064; A63B 37/0062; A63B 37/0043; A63B 37/0039; A63B 37/0096; A63B 37/0067; A63B 37/0066; A63B 37/0065; A63B 37/0045; A63B 37/0047; A63B 37/0046; A63B 37/0033; A63B 37/0035; A63B 37/008; A63B 37/0083; A63B 37/0081; C08L 9/00; C08L 75/08; C08L 67/00; C08L 2205/025; A63B 37/0024

(57) ABSTRACT

In a multi-piece solid golf ball having a two-layer core with an inner core layer and an outer core layer, a cover, and at least one intermediate layer between the core and cover, the inner and outer core layers are formed of different rubber compositions, and the intermediate layer and the cover are formed of different resin compositions. The inner core layer diameter, the hardness relationship between the surface of the outer core layer and the center of the inner core layer, and the material hardness of the intermediate layer fall within specific ranges. Also, within the ball, the intermediate layer-encased sphere has a higher surface hardness than the cover-encased sphere. This golf ball has a larger spin rate-lowering effect on full shots with a driver, resulting in an increased distance, and also has an excellent spin performance on approach shots, thus providing the golfer with a competitive advantage.

### CROSS-REFERENCE TO RELATED APPLICATION

This non-provisional application claims priority under 35 U.S.C. §119(a) on Patent Application No. 2016-235110 filed in Japan on Dec. 2, 2016, the entire contents of which are hereby incorporated by reference.

### TECHNICAL FIELD

This invention relates to a multi-piece solid golf ball having a two-layer core consisting of a rubber inner core layer and a rubber outer core layer, a cover made of resin, and at least one intermediate layer made of resin between the core and the cover.

### BACKGROUND ART

Numerous patent documents describe, in golf balls of two or more pieces that include a core and a cover or in multi-piece solid golf balls of three or more pieces that include a core, an intermediate layer and a cover, increasing the flight distance of the ball or improving ball features such as the feel at impact and durability by adjusting the diameter and hardness distribution of the core and the thickness and hardness of the intermediate layer and the cover. For example, U.S. Pat. Nos. 5,782,707 and 6,679,791 disclose golf balls in which the core is encased with a two-layer cover that is hard on the outside and soft on the inside, thereby producing a spin rate-lowering effect on full shots with a driver (W#1) and in turn increasing the flight distance of the ball. In addition, U.S. Pat. Nos. 7,115,049, 7,267,621 and 7,503,855 describe golf balls having a two-layer core consisting of an inner layer and an outer layer, with the inner core layer designed to at least a given size.

Yet, although each of these prior-art golf balls does indeed exhibit a spin rate-lowering effect on full shots with a driver (W#1), this effect is not large enough. Hence, there remains room for improvement in the spin rate-lowering effect.

Golfers having a mid-to-high-level head speed (HS), particularly mid-to-high-level amateur golfers and professional golfers, desire to use golf balls which not only have an increased flight distance on shots with a driver but also, to increase the enjoyability of the game of golf and provide a competitive edge, have an excellent spin performance on approach shots.

### SUMMARY OF THE INVENTION

It is therefore an object of the present invention to provide a multi-piece solid golf ball which has a large spin rate-lowering effect on full shots with a driver and thus provides an increased distance, and which also imparts an excellent spin performance on approach shots.

As a result of intensive investigations, the inventors have discovered that, in a golf ball having a core, an intermediate layer and a cover, by forming the core as two layers—an inner core layer and an outer core layer—that are made of different rubber compositions, forming the intermediate layer and the cover of different resin compositions, having the inner core layer diameter and the value obtained by subtracting the JIS-C hardness at the center of the inner core layer (Cc) from the JIS-C hardness at the surface of the outer core layer (Css) fall in specific ranges, setting the material hardness of the intermediate layer in a specific range, and designing the golf ball such that the intermediate layer-encased sphere has a higher surface hardness than the cover-encased sphere, the spin rate-lowering effect on full shots with a driver (W#1) increases.

That is, the golf ball of the invention, in order to be of optimal use to, in particular, mid-to-high-level skilled amateur golfers and professionals, has two covering layers—an intermediate layer and a cover—that are hard on the inside and soft on the outside formed over a two-layer core, in this way providing a structure that lowers the spin rate on full shots and enables the ball to travel an increased distance and also achieving an excellent spin performance on approach shots that increases the enjoyability of the game.

Accordingly, the invention provides a multi-piece solid golf ball having a two-layer core with an inner core layer and an outer core layer, a cover, and at least one intermediate layer between the core and the cover, wherein the inner core layer and the outer core layer are formed of different rubber compositions, and the intermediate layer and the cover are formed of different resin compositions. The inner core layer has a diameter of not more than 35.0 mm, the value obtained by subtracting the JIS-C hardness at the center of the inner core layer (Cc) from the JIS-C hardness at the surface of the outer core layer (Css) is at least 25, and the intermediate layer has a material hardness measured on the Shore D scale of at least 65. Also, the sphere obtained by encasing the core with the intermediate layer (referred to herein as the “intermediate layer-encased sphere”) has a higher surface hardness than the sphere obtained by encasing the core and intermediate layer with the cover (referred to herein as the “cover-encased sphere”).

In a preferred embodiment of the golf ball of the invention, the resin composition of the intermediate layer includes at least 50 wt % of an ionomer having an acid content of at least 16 wt %.

In another preferred embodiment of the inventive golf ball, the material hardness of the intermediate layer on the Shore D scale is from 65 to 74.

In yet another preferred embodiment, the rubber composition of the inner core layer includes water.

In still another preferred embodiment, the value obtained by subtracting the JIS-C hardness at the center of the inner core layer (Cc) from the JIS-C hardness at the surface of the inner core layer (Cs) is at least 22.

In a further preferred embodiment of the inventive golf ball, the value obtained by subtracting the JIS-C hardness at the center of the inner core layer (Cc) from the JIS-C hardness at the surface of the outer core layer (Css) is not more than 45.

In a still further preferred embodiment, the core is formed of a rubber composition that includes: (i) a base rubber, (ii) an α,β-unsaturated carboxylic acid and/or a metal salt thereof, (iii) a crosslinking initiator, and (iv) a metal carboxylate in which the carboxylic acid bonded to metal is of two or more different types and at least one of the carboxylic acids has 8 or more carbon atoms.

### ADVANTAGEOUS EFFECTS OF THE INVENTION

The golf ball of the invention has a larger spin rate-lowering effect on full shots with a driver, resulting in an increased distance, and also has an excellent spin performance on approach shots, thus providing the golfer with a competitive advantage.

### BRIEF DESCRIPTION OF THE DIAGRAMS

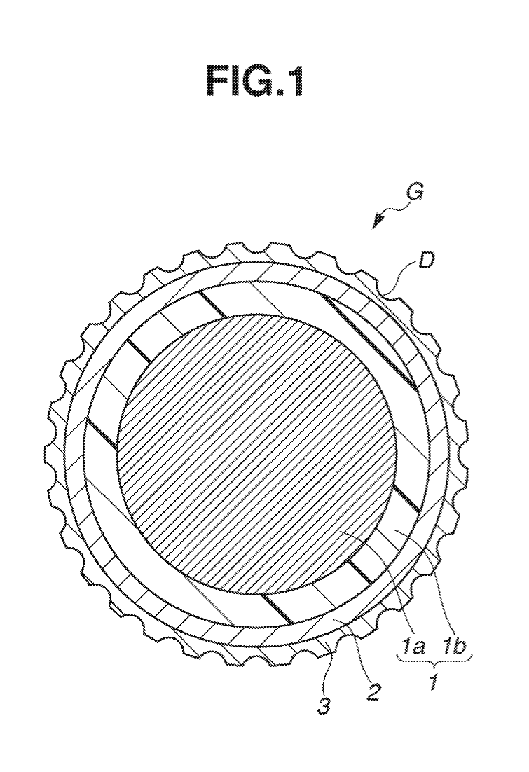

FIG. 1 is a schematic cross-sectional view of a golf ball according to one embodiment of the invention.

### DESCRIPTION OF THE PREFERRED EMBODIMENTS

The objects, features and advantages of the invention will become more apparent from the following detailed description taken in conjunction with the appended diagram.

The multi-piece solid golf ball of the invention has, in order from the inside: an inner core layer, an outer core layer, an intermediate layer and a cover. For example, referring to FIG. 1, the golf ball G has a core 1 consisting of an inner layer la and an outer layer 1b encasing the inner layer 1a, an intermediate layer 2 encasing the core 1, and a cover 3 encasing the intermediate layer 2. In addition, the golf ball typically has numerous dimples D formed on the outer surface of the cover 3 in order to enhance the aerodynamic properties. Each layer is described in detail below.

As mentioned above, the core used in this invention has of at least two layers—an inner core layer and an outer core layer, with the inner core layer corresponding to the center core of the golf ball. The inner core layer material is composed primarily of a rubber material. Specifically, use can be made of a rubber composition that includes (A) a base rubber and (B) an organic peroxide, and also includes, for example, a co-crosslinking agent, an inert filler and, optionally, an organosulfur compound.

Polybutadiene is preferably used as the base rubber (A). The polybutadiene has a cis-1,4 bond content on the polymer chain of typically at least 60 wt %, preferably at least 80 wt %, more preferably at least 90 wt %, and most preferably at least 95 wt %. When the content of cis-1,4 bonds among the bonds in the molecule is too low, the resilience may decrease.

Rubber components other than this polybutadiene may be included in the base rubber (A) within a range that does not detract from the advantageous effects of the invention. Examples of such rubber components other than the foregoing polybutadiene include other polybutadienes, and diene rubbers other than polybutadiene, such as styrene-butadiene rubber, natural rubber, isoprene rubber and ethylene-propylene-diene rubber.

The organic peroxide (B) is not particularly limited, although the use of an organic peroxide having a one-minute half-life temperature of between 110 and 185° C. is preferred. One, two or more organic peroxides may be used. The content of organic peroxide per 100 parts by weight of the base rubber is preferably at least 0.1 part by weight, and more preferably at least 0.3 part by weight. The upper limit is preferably not more than 5 parts by weight, more preferably not more than 4 parts by weight, and even more preferably not more than 3 parts by weight. A commercial product may be used as the organic peroxide. Specific examples include those available under the trade names Percumyl D, Perhexa C-40, Niper BW and Peroyl L (all from NOF Corporation), and Luperco 231XL (from Atochem Co.).

The co-crosslinking agent is exemplified by unsaturated carboxylic acids and the metal salts of unsaturated carboxylic acids. Illustrative examples of unsaturated carboxylic acids include acrylic acid, methacrylic acid, maleic acid and fumaric acid. Acrylic acid and methacrylic acid are especially preferred. Metal salts of unsaturated carboxylic acids are not particularly limited, and are exemplified by those obtained by neutralizing the foregoing unsaturated carboxylic acids with the desired metal ions. Illustrative examples include the zinc salts and magnesium salts of methacrylic acid and acrylic acid. The use of zinc acrylate is especially preferred.

These unsaturated carboxylic acids and/or metal salts thereof are included in an amount, per 100 parts by weight of the base rubber, which is typically at least 10 parts by weight, preferably at least 15 parts by weight, and more preferably at least 20 parts by weight. The upper limit is typically not more than 60 parts by weight, preferably not more than 50 parts by weight, more preferably not more than 45 parts by weight, and most preferably not more than 40 parts by weight. When too much is included, the feel of the ball may become too hard and unpleasant. When too little is included, the rebound may decrease.

The inner core layer is preferably formed of a hot-molded rubber composition containing as the essential ingredients: (A) a base rubber, (B) an organic peroxide, and (C) water.

Decomposition of the organic peroxide within the core formulation can be promoted by the direct addition of water (or a water-containing material) to the core material. It is known that the decomposition efficiency of the organic peroxide within the core-forming rubber composition changes with temperature and that, starting at a given temperature, the decomposition efficiency rises with increasing temperature. If the temperature is too high, the amount of decomposed radicals rises excessively, leading to recombination between radicals and, ultimately, deactivation. As a result, fewer radicals act effectively in crosslinking. Here, when a heat of decomposition is generated by decomposition of the organic peroxide at the time of core vulcanization, the vicinity of the core surface remains at substantially the same temperature as the temperature of the vulcanization mold, but the temperature near the core center, due to the build-up of heat of decomposition by the organic peroxide which has decomposed from the outside, becomes considerably higher than the mold temperature. In cases where water (or a water-containing material) is added directly to the core, because the water acts to promote decomposition of the organic peroxide, radical reactions like those described above can be made to differ at the core center and at the core surface. That is, decomposition of the organic peroxide is further promoted near the center of the core, bringing about greater radical deactivation, which leads to a further decrease in the amount of active radicals. As a result, it is possible to obtain a core in which the crosslink densities at the core center and the core surface differ markedly. It is also possible to obtain a core having different dynamic viscoelastic properties at the core center. Along with achieving a lower spin rate, golf balls having such a core are also able to exhibit excellent durability and undergo less change over time in rebound.

Components (A) and (B) are as described above.

The water serving as component (C) is not particularly limited, and may be distilled water or tap water. The use of distilled water that is free of impurities is especially preferred. The amount of water included per 100 parts by weight of the base rubber is preferably at least 0.1 part by weight, and more preferably at least 0.3 parts by weight. The upper limit is preferably not more than 5 parts by weight, and more preferably not more than 4 parts by weight.

By including a suitable amount of such water, the moisture content in the rubber composition before vulcanization becomes preferably at least 1,000 ppm, and more preferably at least 1,500 ppm. The upper limit is preferably not more than 8,500 ppm, and more preferably not more than 8,000 ppm. When the moisture content of the rubber composition is too low, it may be difficult to obtain a suitable crosslink density and tan δ, which may make it difficult to mold a golf ball having little energy loss and a reduced spin rate. On the other hand, when the moisture content of the rubber composition is too high, the core may be too soft, which may make it difficult to obtain a suitable core initial velocity.

Although it is also possible to add water directly to the rubber composition, the following methods (i) to (iii) may be employed to incorporate water:
(i) applying water in the form of a mist, as steam or by means of ultrasound, to some or all of the rubber composition (compounded material);
(ii) immersing some or all of the rubber composition in water;
(iii) letting some or all of the rubber composition stand for a given period of time in a high-humidity environment in a place where the humidity can be controlled, such as a constant humidity chamber.

As used herein, “high-humidity environment” is not particularly limited, so long as it is an environment capable of moistening the rubber composition, although a humidity of from 40 to 100% is preferred.

Alternatively, the water may be worked into a jelly state and added to the above rubber composition. Or a material obtained by first supporting water on a filler, unvulcanized rubber, rubber powder or the like may be added to the rubber composition. In such a form, the workability is better than when water is directly added to the composition, enabling the efficiency of golf ball production to be increased. The type of material in which a given amount of water has been included, although not particularly limited, is exemplified by fillers, unvulcanized rubbers and rubber powders in which sufficient water has been included. The use of a material which undergoes no loss of durability or resilience is especially preferred. The moisture content of the above material is preferably at least 3 wt %, more preferably at least 5 wt %, and even more preferably at least 10 wt %. The upper limit is preferably not more than 99 wt %, and even more preferably not more than 95 wt %.

In addition, a metal carboxylate in which the carboxylic acid bonded to metal is of two or more different types and at least one of the carboxylic acids has 8 or more carbon atoms may be included in the rubber composition. This metal carboxylate (referred to below as “the specified metal carboxylate”) is described below.

### Specified Metal Carboxylate

The specified metal carboxylate is a compound in which the carboxylic acid bonded to metal is of two or more different types and at least one of the carboxylic acids has 8 or more carbon atoms. As used herein, “bond” refers to a bond between a metal and a carboxylic acid; the number of bonds varies depending on the metal species. Specifically, sodium and potassium have one bonding site, zinc and calcium have two, and iron and aluminum have three. Because the number of bonding sites on the metal must be two or more in order for the compound to be able to serve as the specified metal carboxylate, the metal species is limited to those have two or more bonding sites. In the case of a zinc salt, for example, if the zinc is bonded at one of its two bonding sites to a carboxylic acid A having 8 or more carbon atoms, the second carboxylic acid must be one other than carboxylic acid A. Such carboxylic acids are denoted herein with names having the prefix “mono” to distinguish them from metal salts with two bonds in which the carboxylic acids bonded to the metal are both the same (disalts), such as zinc stearate. Illustrative examples of the specified metal carboxylate include compounds of structural formula (1) or (2) below.

R¹-M¹-R² (1)

In formula (1), R¹ and R² are each different carboxylic acids, with at least one of R¹ and R² having 8 or more carbon atoms. M¹ represents a divalent metal atom.

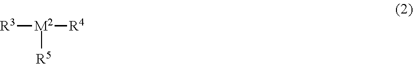

In formula (2), R³ to R⁵ are two or more different carboxylic acids, with at least one of R³ to R⁵ having 8 or more carbon atoms. M² represents a trivalent metal atom.

By having the specified metal carboxylate be two or more different carboxylic acids bonded to a metal, with at least one of the carboxylic acids having 8 or more carbon atoms, the processability can be improved and the decrease in the initial velocity of the core owing to addition of the specified metal carboxylate can be held to a minimum.

In the specified metal carboxylate, it is preferable for at least one of the carboxylic acids bonded to the metal to be an unsaturated carboxylic acid, and more preferable for the unsaturated carboxylic acid to be an α,β-unsaturated carboxylic acid having from 3 to 8 carbon atoms. Also, it is especially preferable for the metal species in the specified metal carboxylate to be one selected from the group consisting of zinc, calcium, magnesium, copper, aluminum, iron and zirconium.

Illustrative examples of the specified metal carboxylate include zinc monostearate monopalmitate, zinc monostearate monomyristate, zinc monostearate monolaurate, zinc monopalmitate monomyristate, zinc monopalmitate monolaurate, zinc monostearate monoacrylate, zinc monostearate monomethacrylate, zinc monostearate monomaleate, zinc monostearate monofumarate, zinc monopalmitate monoacrylate, zinc monopalmitate monomethacrylate, zinc monopalmitate monomaleate, zinc monopalmitate monofumarate, zinc monomyristate monoacrylate, zinc monomyristate monomethacrylate, zinc monomyristate monomaleate, zinc monomyristate monofumarate, zinc monolaurate monoacrylate, zinc monolaurate monomethacrylate, zinc monolaurate monomaleate and zinc monolaurate monofumarate. Zinc monostearate monoacrylate is preferred. Cases where the carboxylic acids bonded to the metal are the same, such as zinc stearate, do not fall within the scope of this invention.

The form of the specified metal carboxylate within the rubber composition is not particularly limited. For example, it may be present in a form that is mixed and dispersed, within the rubber composition, together with the above co-crosslinking agent. Another form is one in which the surface of the co-crosslinking agent such as zinc acrylate is coated with the specified metal carboxylate. That is, the specified metal carboxylate may be included in the rubber composition as a coating layer.

The specified metal carboxylate can be easily obtained by reacting a metal compound in the presence of a plurality of carboxylic acids. Specifically, in the case of zinc monostearate monoacrylate, this can be obtained by dissolving stearate acid and acrylic acid in a reaction solution and mixing therein zinc oxide suspended in a solvent so as to induce the reaction. Alternatively, it can be obtained by adding stearic acid and acrylic acid to a solution obtained by suspending zinc oxide in a solvent.

The content of the specific metal carboxylate per 100 parts by weight of the base rubber is preferably from 0.1 to 50 parts by weight, and more preferably from 1 to 25 parts by weight. The weight ratio of the specific metal carboxylate to the total amount of co-crosslinking agent is preferably from 1 to 99 wt %, and more preferably from 4 to 50 wt %. When the content of the specific metal carboxylate is lower than this range, a sufficient processability improving effect may not be obtainable. On the other hand, when the content is higher than this range, the initial velocity of the core may decrease more than necessary.

Production of the inner core layer may be carried out in the usual manner by heat and compression molding under vulcanization conditions of at least 140° C. and not more than 180° C. for at least 10 minutes and not more than 60 minutes to give a spherical molded material (inner core layer).

It is recommended that the inner core layer have a diameter of preferably at least 15 mm, more preferably at least 17.5 mm, and even more preferably at least 20 mm, with the upper limit being not more than 35.0 mm, more preferably not more than 30 mm, and even more preferably not more than 25 mm. At an inner core layer diameter smaller that this range, the initial velocity of the ball on shots with a driver (W#1) may decrease, as a result of which the intended distance may not be obtained. On the other hand, when the diameter is larger than this range, the durability of the ball to cracking on repeated impact may worsen or the spin rate-lowering effect on full shots may be inadequate, as a result of which the intended distance may not be obtained.

The inner core layer has a center hardness (Cc) on the JIS-C scale of preferably from 39 to 61, more preferably from 42 to 58, and even more preferably from 45 to 55. When this value is too large, the spin rate may rise excessively, possibly shortening the distance traveled by the ball and the feel at impact may become hard. On the other hand, when this value is too small, the durability to cracking on repeated impact may worsen and the feel at impact may become too soft.

The inner core layer has a surface hardness (Cs) on the JIS-C scale of preferably from 64 to 86, more preferably from 67 to 83, and even more preferably from 70 to 80. When this value is too large, the durability of the ball to cracking on repeated impact may worsen. On the other hand, when this value is too small, the spin rate may rise on full shots, as a result of which the intended distance may not be obtained.

The hardness difference between the surface and center of the inner core layer, i.e., the value (Cs)-(Cc), is preferably at least 19, more preferably at least 21, and even more preferably at least 22. The upper limit is preferably not more than 39, more preferably not more than 34, and even more preferably not more than 29. When this value is too large, the initial velocity on full shots may become low, as a result of which the intended distance may not be achieved, or the durability of the ball to cracking on repeated impact may worsen. On the other hand, when this value is too small, the spin rate on full shots may rise, as a result of which the intended distance may not be achieved.

The rubber composition for the outer core layer in this invention may be one that uses ingredients similar to those in the rubber composition for the inner core layer. However, the compounding details (i.e., ingredients and their contents) for the outer core layer-forming rubber composition differ from those for the inner core layer-forming rubber composition, and the outer core layer is produced by vulcanizing/curing this rubber composition. Production of this outer core layer may be advantageously carried out using, for example, a process that divides vulcanization of the outer core layer material into two stages: first, the outer core layer material is placed in an outer core layer mold and initial vulcanization (semi-vulcanization) is carried out to produce a pair of hemispherical cups; next, a prefabricated inner core layer is placed in one of the hemispherical cups and is then covered with the other hemispherical cup, in which state secondary vulcanization (complete vulcanization) is carried out. Alternatively, advantageous use can be made of a method that carries out production of the entire core concurrent with molding of the outer core layer. The vulcanization conditions used during molding of the outer core layer are the same as those mentioned above for production of the inner core layer.

The outer core layer has a thickness of preferably from 2.0 to 14.0 mm, more preferably from 4.0 to 12.0 mm, and even more preferably from 6.0 to 10.0 mm. When this thickness is too large, the initial velocity of the ball on full shots may decrease, as a result of which the intended distance may not be obtained. On the other hand, when this thickness is too small, the durability of the ball to cracking on repeated impact may worsen, or the spin rate-lowering effect on full shots may be inadequate, as a result of which the intended distance may not be obtained.

The outer core layer has a surface hardness (Css) on the JIS-C scale of preferably at least 80, more preferably from 81 to 95, and even more preferably from 82 to 93. When this value is too large, the feel at impact may become harder or the durability of the ball to cracking on repeated impact may worsen. On the other hand, when this value is too small, the spin rate may rise excessively or the rebound may decrease, as a result of which a good distance may not be achieved.

The hardness difference between the surface of the outer core layer and the center of the inner core layer, which value is expressed as (Css)-(Cc), must be at least 25, and is preferably at least 28, and more preferably at least 30. The upper limit for this hardness difference is preferably not more than 50, and more preferably not more than 45. When this value is too large, the durability to cracking on repeated impact may worsen. On the other hand, when this value is too small, the spin rate may rise excessively, as a result of which a good distance may not be achieved.

The center hardness (Cc) of the inner core layer refers to the hardness measured at the center of the cross-section obtained by cutting the inner core layer in half through the center. The surface hardness (Cs) of the inner core layer and the surface hardness (Css) of the outer core layer refer to the hardnesses measured at the spherical surfaces of, respectively, the inner core layer and the outer core layer.

The inner core layer (sphere) has a deformation under given loading, or deflection, when compressed under a final load of 1,275 N (130 kgf) from an initial load of 98 N (10 kgf) which, although not particularly limited, is preferably from 4.5 to 10.0 mm, more preferably form 5.5 to 9.0 mm, and even more preferably from 6.5 to 8.0 mm. The sphere obtained by encasing the inner core layer with the outer core layer, i.e., the overall core, has a deflection (mm) when compressed under a final load of 1,275 N (130 kgf) from an initial load of 98 N (10 kgf) of preferably from 3.1 to 4.3 mm, more preferably from 3.3 to 4.1 mm, and even more preferably from 3.5 to 3.9 mm. When this value is too large, the feel at impact may be too soft, the durability on repeated impact may worsen, or the initial velocity of the ball on full shots may decline, as a result of which the intended distance may not be achieved. On the other hand, when this value is too small, the feel at impact may be too hard and the spin rate on full shots may rise, as a result of which the intended distance may not be obtained.

Next, the resin material making up the intermediate layer is described.

The intermediate layer-forming material is not particularly limited, although the use of various types of known resin materials, especially ionomer resin materials or highly neutralized resin materials, is preferred.

When an ionomer resin is used as the intermediate layer material, the content of unsaturated carboxylic acid (acid content) included in the intermediate layer material is preferably at least 16 wt %, and more preferably at least 18 wt %, with the upper limit being preferably not more than 22 wt %, and more preferably not more than 20 wt %. At a low acid content, the rebound may decrease or the spin rate may increase, as a result of which a good distance may not be obtained. On the other hand, at a high acid content, the processability may decrease or the durability to cracking on repeated impact may worsen.

It is suitable to use as the intermediate layer material in the invention an ionomer having an acid content of at least 16 wt %. Including such a high acid-content ionomer as at least 50 wt % of the overall resin material is especially preferred from the standpoint of obtaining the desired hardness, rebound and durability.

Specific examples of the intermediate layer material used in the invention include commercial ionomers available under the trade names AM7315, AM7317 and AM7318 from DuPont-Mitsui Polychemicals Co., Ltd., and under the trade names AD8546, AD8547 and AD8548 from E.I. DuPont de Nemours & Co.

The intermediate layer has a material hardness on the Shore D scale which, although not particularly limited, is preferably at least 65, and more preferably at least 66, with the upper limit being preferably not more than 74, more preferably not more than 72, and even more preferably not more than 70. The intermediate layer-encased sphere (referred to below as the “intermediate layer-encased sphere”) has a surface hardness on the Shore D scale of preferably at least 71, and more preferably at least 72, with the upper limit being preferably not more than 80, more preferably not more than 78, and even more preferably not more than 76. When the intermediate layer material or the intermediate layer-encased sphere is softer than the above respective hardness range, the ball may be too susceptible to spin on full shots, as a result of which a good distance may not be obtained. On the other hand, when the intermediate layer material or the intermediate layer-encased sphere is harder than the above respective hardness range, the durability of the ball to cracking on repeated impact may worsen or the feel at impact on shots with a putter or on approach shots may become too hard.

As used herein, “intermediate layer-encased sphere surface hardness” refers to the hardness at the surface of the sphere composed of the core encased by the intermediate layer material, and is determined by such factors as the hardness of the underlying core and the thickness and hardness of the intermediate layer; this differs from the hardness of the intermediate layer material itself. The surface hardness of the intermediate layer-encased sphere tends to be harder than the hardness of the intermediate layer material itself.

The sphere composed of the above two-layer core encased by the intermediate layer, that is, the intermediate layer-encased sphere, has a deflection when compressed under a final load of 1,275 N (130 kgf) from an initial load of 98 N (10 kgf) which, although not particularly limited, is preferably from 2.4 to 3.6 mm, more preferably from 2.6 to 3.4 mm, and even more preferably from 2.8 to 3.1 mm. When this value is too large, the feel at impact may be too soft, the durability to cracking on repeated impact may worsen, or the initial velocity on full shots may be low, as a result of which the intended distance may not be obtained. On the other hand, when this value is too small, the feel at impact may be too hard and the spin rate on full shots may be too high, as a result of which the intended distance may not be obtained.

The intermediate layer has a thickness which, although not particularly limited, is preferably at least 0.7 mm, more preferably at least 0.9 mm, and even more preferably at least 1.1 mm, with the upper limit being preferably not more than 2.0 mm, more preferably not more than 1.6 mm, and even more preferably not more than 1.3 mm. At an intermediate layer thickness outside of the above numerical range, the spin rate-lowering effect on shots with a driver (W#1) may be inadequate, as a result of which a good distance may not be achieved.

Next, the cover serving as the outermost layer of the ball is described.

The cover (outermost layer) material is not particularly limited; various types of thermoplastic resin materials may be suitably used. For reasons having to do with ball controllability and scuff resistance, a polyurethane material is used as the base resin of the cover material. In particular, from the standpoint of the mass productivity of manufactured golf balls, it is preferable to use a cover material composed primarily of thermoplastic polyurethane, with formation being preferably carried out using a resin blend in which the primary components are (O) a thermoplastic polyurethane and (P) a polyisocyanate compound.

In the thermoplastic polyurethane composition containing above components (O) and (P), to improve the ball properties even further, a necessary and sufficient amount of unreacted isocyanate groups should be present in the cover resin material. Specifically, it is recommended that the combined weight of components (O) and (P) be at least 60%, and more preferably at least 70%, of the weight of the overall cover layer. Components (O) and (P) are described below in detail.

The thermoplastic polyurethane (O) has a structure which includes soft segments composed of a polymeric polyol (polymeric glycol) that is a long-chain polyol, and hard segments composed of a chain extender and a polyisocyanate compound. Here, the long-chain polyol serving as a starting material may be any that has hitherto been used in the art relating to thermoplastic polyurethanes, and is not particularly limited. Illustrative examples include polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. These long-chain polyols may be used singly, or two or more may be used in combination. Of these, in terms of being able to synthesize a thermoplastic polyurethane having a high rebound resilience and excellent low-temperature properties, a polyether polyol is preferred.

Any chain extender that has hitherto been employed in the art relating to thermoplastic polyurethanes may be advantageously used as the chain extender. For example, low-molecular-weight compounds with a molecular weight of 400 or less which have on the molecule two or more active hydrogen atoms capable of reacting with isocyanate groups are preferred. Illustrative, non-limiting, examples of the chain extender include 1,4-butylene glycol, 1,2-ethylene glycol, 1,3-butanediol, 1,6-hexanediol and 2,2-dimethyl-1,3-propanediol. Of these, the chain extender is preferably an aliphatic diol having 2 to 12 carbon atoms, and more preferably 1,4-butylene glycol.

Any polyisocyanate compound hitherto employed in the art relating to thermoplastic polyurethanes may be suitably used without particular limitation as the polyisocyanate compound. For example, use may be made of one, two or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate and dimer acid diisocyanate. However, depending on the type of isocyanate, the crosslinking reactions during injection molding may be difficult to control. In the practice of the invention, to provide a balance between stability at the time of production and the properties that are manifested, it is most preferable to use the following aromatic diisocyanate: 4,4′-diphenylmethane diisocyanate.

Commercially available products may be used as the thermoplastic polyurethane serving as component (O). Illustrative examples include Pandex T-8295, T-8290, T-8283 and T-8260 (all from DIC Bayer Polymer, Ltd.).

Although not an essential ingredient, a thermoplastic elastomer other than the above thermoplastic polyurethane may be included as an additional component together with components (O) and (P). By including this component (Q) in the above resin blend, a further improvement in the flowability of the resin blend can be achieved and the properties required of a golf ball cover material, such as resilience and scuff resistance, can be enhanced.

The relative proportions of above components (O), (P) and (Q) are not particularly limited. However, to fully elicit the advantageous effects of the invention, the weight ratio (O):(P):(Q) is preferably from 100:2:50 to 100:50:0, and more preferably from 100:2:50 to 100:30:8.

In addition to the ingredients making up the thermoplastic polyurethane, various additives may be optionally included in the above resin blend. For example, pigments, dispersants, antioxidants, light stabilizers, ultraviolet absorbers and internal mold lubricants may be suitably included.

The cover (outermost layer) has a material hardness on the Shore D scale which, although not particularly limited, is preferably at least 30, more preferably at least 35, and even more preferably at least 40, with the upper limit being preferably not more than 58, more preferably not more than 54, and even more preferably not more than 50. Also, the surface hardness of the cover-encased sphere, i.e., the surface hardness of the overall ball, on the Shore D scale is preferably at least 25, more preferably at least 40, and even more preferably at least 45, with the upper limit being preferably not more than 70, more preferably not more than 66, and even more preferably not more than 62. When the surface hardness is lower than this range, the spin rate on driver (W#1) shots or on full shots with an iron becomes too high, as a result of which a good distance may not be achieved. On the other hand, when the surface hardness is higher than this range, the spin rate on approach shots may be inadequate or the feel at impact may be too hard.

As used herein, the surface hardness of the cover (outermost layer)-encased sphere, i.e., the ball, refers to the hardness at the surface of the sphere obtained by encasing the intermediate layer-encased sphere with the cover material. This surface hardness is suitably determined by, for example, the thicknesses and hardnesses of the underlying core, the intermediate layer and the cover, and differs from the hardness of the cover material itself. Also the surface hardness of the cover-encased sphere (ball) tends to be higher than the hardness of the cover material itself.

The cover (outermost layer) has a thickness which is preferably at least 0.3 mm, more preferably at least 0.45 mm, and even more preferably at least 0.6 mm, with the upper limit being preferably not more than 1.5 mm, more preferably not more than 1.2 mm, and even more preferably not more than 0.9 mm. A cover that is thicker than this range may result in an inadequate resilience or a higher spin rate on shots with a driver (W#1) and shots with an iron, as a result of which a good distance may not be obtained. On the other hand, when the cover is thinner than the above range, the scuff resistance may worsen or the ball may not be susceptible to spin on approach shots and may therefore lack suitable controllability.

The cover (outermost layer)-encased sphere, i.e., the ball, has a deflection when compressed under a final load of 1,275 N (130 kgf) from an initial load of 98 N (10 kgf) which, although not particularly limited, is preferably from 2.1 to 3.6 mm, more preferably from 2.3 to 3.3 mm, and even more preferably from 2.5 to 3.0 mm. When this value is too large, the feel at impact may be too soft, the durability on repeated impact may worsen, or the initial velocity on full shots may decrease, as a result of which the intended distance may not be obtained. On the other hand, when this value is too small, the feel at impact may become too hard or the spin rate on full shots may become too high, as a result of which the intended distance may not be obtained.

The manufacture of multi-piece solid golf balls in which the above-described core composed of an inner core layer and an outer core layer and the above-described intermediate layer and cover (outermost layer) are formed as successive layers may be carried out by a customary method such as a known injection-molding process. For example, a multi-piece golf ball may be obtained by placing a core consisting of inner and outer layers composed primarily of rubber materials in a given injection mold, injecting an intermediate layer material over the core to give an intermediate sphere, and subsequently placing the intermediate sphere in another injection mold and injection-molding a cover (outermost layer) material over the intermediate sphere. Alternatively, the cover (outermost layer) may be formed by a method that involves encasing the intermediate sphere within a cover, this being carried out by, for example, enclosing the intermediate sphere in two half-cups that have been pre-molded into hemispherical shapes, and then molding under applied heat and pressure.

The golf ball of the invention also preferably satisfies the following conditions.

### (I) Relationship Among Deflections of Core, Intermediate Layer-Encased Sphere and Ball

Letting T₁ be the deflection (mm) of the inner core layer when compressed under a final load of 1,275 N (130 kgf) from an initial load of 98 N (10 kgf) and T₂ be the deflection (mm) of the sphere consisting of the inner core layer encased by the outer core layer when compressed under a final load of 1,275 N (130 kgf) from an initial load of 98 N (10 kgf), the value T₁/T₂ is preferably not more than 3.0, more preferably from 1.0 to 2.7, and even more preferably from 1.5 to 2.5. Also, letting T₃ be the deflection (mm) of the sphere consisting of the above core encased by the intermediate layer (i.e., the intermediate layer-encased sphere) when compressed under a final load of 1,275 N (130 kgf) from an initial load of 98 N (10 kgf), the value T₁/T₃ is preferably not more than 4.0, more preferably from 1.5 to 3.5, and even more preferably from 2.0 to 3.0. In addition, letting T₄ be the deflection (mm) of the ball when compressed under a final load of 1,275 N (130 kgf) from an initial load of 98 N (10 kgf), the value T₁/T₄ is preferably not more than 4.1, more preferably from 1.7 to 3.6, and even more preferably from 2.2 to 3.1. When the above values T₁/T₂, T₁/T₃ and T₁/T₄ are larger than the above respective ranges, the feel at impact may be too soft, or the initial velocity on full shots may be too low, as a result of which the ball may not achieve the intended distance on shots with a driver. On the other hand, when the above values are too small, the feel at impact may be too hard, or the spin rate on full shots may rise excessively, as a result of which the ball may not achieve the intended distance on shots with a driver.

### (II) Relationship Between Intermediate Layer and Cover Thicknesses

The value obtained by subtracting the cover thickness from the intermediate layer thickness is preferably from −0.1 to 1.0 mm, more preferably from 0.1 to 0.8 mm, and even more preferably from 0.3 to 0.6 mm. When this value is too large, the feel at impact may be too hard and the ball may not be very receptive to spin on approach shots. On the other hand, when the above value is too small, the durability to cracking on repeated impact may worsen, or the spin rate-lowering effect on full shots may be inadequate, as a result of which the intended distance may not be obtained.

(III) Relationship among Surface Hardnesses of Outer Core Layer, Intermediate Layer-Encased Sphere and Ball

The value obtained by subtracting the surface hardness of the outer core layer on the Shore D scale from the surface hardness of the intermediate layer-encased sphere on the Shore D scale is preferably from 1 to 25, more preferably from 5 to 20, and even more preferably from 10 to 15. Outside of this range, the spin rate-lowering effect on full shots may be inadequate, as a result of which the intended distance may not be obtained, and the durability to cracking on repeated impact may worsen. Also, the value obtained by subtracting the surface hardness of the intermediate layer-encased sphere on the Shore D scale from the surface hardness of the ball on the Shore D scale is preferably from −21 to −1, more preferably from −18 to −3, and even more preferably from −15 to −5. When this value is too large (less negative), the ball may not be susceptible to spin on approach shots or may have a poor durability to cracking on repeated impact. On the other hand, when this value is too small (more negative), the spin rate on full shots may rise and the initial velocity of the ball may decrease, as a result of which the intended distance may not be obtained.

Numerous dimples may be formed on the outer surface of the cover (outermost layer). The number of dimples arranged on the cover surface, although not particularly limited, may be set to preferably at least 280, more preferably at least 300, and even more preferably at least 320, with the upper limit being preferably not more than 360, more preferably not more than 350, and even more preferably not more than 340. When the number of dimples is higher than this range, the ball trajectory may become low, as a result of which the distance may decrease. On the other hand, when the number of dimples is lower than this range, the ball trajectory may become high, as a result of which a good distance may not be achieved.

The dimple shapes that are used may be of one type or may be a combination of two or more types selected from among circular shapes, various polygonal shapes, dewdrop shapes and oval shapes. When circular dimples are used, the dimple diameter may be set to at least about 2.5 mm and up to about 6.5 mm, and the dimple depth may be set to at least 0.08 mm and up to about 0.30 mm.

In order to fully manifest the aerodynamic properties, it is desirable for the dimple coverage ratio on the spherical surface of the golf ball, i.e., the ratio SR of the sum of the individual dimple surface areas, each defined by the flat plane circumscribed by the edge of a dimple, with respect to the spherical surface area of the ball were it to have no dimples thereon, to be set to at least 60% and up to 90%. Also, to optimize the ball trajectory, it is desirable for the value V₀, defined as the spatial volume of the individual dimples below the flat plane circumscribed by the dimple edge, divided by the volume of the cylinder whose base is the flat plane and whose height is the maximum depth of the dimple from the base, to be set to at least 0.35 and up to 0.80. Moreover, it is preferable for the ratio VR of the sum of the volumes of the individual dimples, each formed below the flat plane circumscribed by the edge of a dimple, with respect to the volume of the ball sphere were the ball surface to have no dimples thereon, to be set to at least 0.6% and up to 1.0%.

Outside of the above ranges in these respective values, the resulting trajectory may not enable a good distance to be obtained, and so the ball may fail to travel a fully satisfactory distance.

The multi-piece solid golf ball of the invention can be made to conform to the Rules of Golf for play. Specifically, the inventive ball may be formed to a diameter which is such that the ball does not pass through a ring having an inner diameter of 42.672 mm and is not more than 42.80 mm, and to a weight which is preferably from 45.0 to 45.93 g.

### EXAMPLES

The following Examples and Comparative Examples are provided to illustrate the invention, and are not intended to limit the scope thereof.

### Examples 1 to 4

### Comparative Examples 1 to 6

### Formation of Inner and Outer Core Layers

Cores for each Working Example of the invention and each Comparative Example were produced by preparing the inner and outer core layer rubber compositions shown in Table 1 below, and then molding and vulcanizing the compositions under the vulcanization conditions shown in Table 1. In Comparative Example 1, a single-layer core lacking an outer core layer was used. In Comparative Example 2, instead of a rubber composition, the resin material shown in Table 2 below as “Resin c” was used as the inner core layer material.

TABLE 1

| | | Working Example | | | | Comparative Example | | | | | |
|---|---|---|---|---|---|---|---|---|---|---|---|
| | | 1 | 2 | 3 | 4 | 1 | 2 | 3 | 4 | 5 | 6 |
| Inner core | Type | No. 1 | No. 1 | No. 12 | No. 12 | No. 2 | Resin | No. 1 | No. 1 | No. 3 | No. 10 |
| layer | Polybutadiene A | 80 | 80 | 80 | 80 | 80 | material | 80 | 80 | 80 | 80 |
| formulation | Polybutadiene B | 20 | 20 | 20 | 20 | 20 | (Table 2, | 20 | 20 | 20 | 20 |
| (pbw) | Unsaturated | 11.5 | 11.5 | 11.5 | 11.5 | 19.6 | Resin c) | 11.5 | 11.5 | 11.5 | 25.5 |
| | metal carboxylate | | | | | | | | | | |
| | Metal carboxylate 1 | | | 2.0 | 2.0 | | | | | | |
| | Metal carboxylate 2 | 2.0 | 2.0 | | | 3.5 | | 2.0 | 2.0 | 2.0 | 4.5 |
| | Organic peroxide (1) | 1.0 | 1.0 | 1.0 | 1.0 | 0.6 | | 1.0 | 1.0 | 1.0 | 1.0 |
| | Organic peroxide (2) | | | | | 0.6 | | | | | |
| | Distilled water | 0.8 | 0.8 | 0.8 | 0.8 | | | 0.8 | 0.8 | 0.8 | 0.8 |
| | Antioxidant | 0.1 | 0.1 | 0.1 | 0.1 | 0.1 | | 0.1 | 0.1 | 0.1 | 0.1 |
| | Barium sulfate (1) | 23.9 | 23.9 | 23.9 | 23.9 | 17.0 | | 23.9 | 23.9 | 15.9 | 15.6 |
| | Zinc oxide | 4 | 4 | 4 | 4 | 5 | | 4 | 4 | 4 | 4 |
| | Zinc salt of | 1 | 1 | 1 | 1 | 0.2 | | 1 | 1 | 1 | 0.2 |
| | pentachlorothiophenol | | | | | | | | | | |
| Vulcanization | Temperature (° C.) | 155 | 155 | 155 | 155 | 155 | | 155 | 155 | 155 | 155 |
| conditions | Time (min) | 13 | 13 | 13 | 13 | 13 | | 13 | 13 | 13 | 13 |
| Outer core | Type | No. 4 | No. 13 | No. 14 | No. 15 | None | No. 5 | No. 6 | No. 4 | No. 7 | No. 11 |
| layer | Polybutadiene A | 80 | 80 | 80 | 80 | | 80 | 80 | 80 | 80 | 80 |
| formulation | Polybutadiene B | 20 | 20 | 20 | 20 | | 20 | 20 | 20 | 20 | 20 |
| (pbw) | Unsaturated | 30.6 | 28.9 | 30.6 | 28.9 | | 30.6 | 30.6 | 30.6 | 30.6 | 30.6 |
| | metal carboxylate | | | | | | | | | | |
| | Metal carboxylate 1 | | | 5.4 | 5.1 | | | | | | |
| | Metal carboxylate 2 | 5.4 | 5.1 | | | | 5.4 | 5.4 | 5.4 | 5.4 | 5.4 |
| | Organic peroxide (2) | 1.2 | 1.2 | 1.2 | 1.2 | | 1.2 | 1.2 | 1.2 | 1.2 | 1.2 |
| | Antioxidant | 0.1 | 0.1 | 0.1 | 0.1 | | 0.1 | 0.1 | 0.1 | 0.1 | 0.1 |
| | Barium sulfate (1) | 11.9 | 12.8 | 11.9 | 11.9 | | 19.9 | 11.0 | 11.9 | 4.6 | 11.8 |
| | Zinc oxide | 4 | 4 | 4 | 4 | | 4 | 4 | 4 | 4 | 4 |
| | Zinc salt of | 0.2 | 0.2 | 0.2 | 0.2 | | 0.2 | 0.2 | 0.2 | 0.2 | 0.2 |
| | pentachlorothiophenol | | | | | | | | | | |
| Vulcanization | Temperature (° C.) | 155 | 155 | 155 | 155 | | 155 | 155 | 155 | 155 | 155 |
| conditions | Time (min) | 13 | 13 | 13 | 13 | | 13 | 13 | 13 | 13 | 13 |

Details on the ingredients shown in Table 1 are given below.
Polybutadiene A: Available under the trade name “BR 01” from JSR Corporation
Polybutadiene B: Available under the trade name “BR 51” from JSR Corporation
Unsaturated metal carboxylate: Zinc acrylate (Wako Pure Chemical Industries, Ltd.)
Metal carboxylate 1: Zinc monoacrylate monostearate (available from Nippon Shokubai Co., Ltd.)
Metal carboxylate 2: Zinc stearate (available from Wako Pure Chemical Industries, Ltd.)
Organic peroxide (1): Dicumyl peroxide, available under the trade name “Percumyl D” from NOF Corporation
Organic peroxide (2): A mixture of 1,1-di(t-butylperoxy)cyclohexane and silica, available under the trade name “Perhexa C-40” from NOF Corporation
Distilled water: Available from Wako Pure Chemical Industries, Ltd.
Antioxidant: 2,2′-Methylenebis(4-methyl-6-butylphenol), available under the trade name “Nocrac NS-6” from Ouchi Shinko Chemical Industry Co., Ltd.
Barium sulfate: Available under the trade name “Barico #100” from Hakusui Tech
Zinc oxide: Available as “Zinc Oxide Grade 3” from Sakai Chemical Co., Ltd.
Zinc salt of pentachlorothiophenol: Available from Wako Pure Chemical Industries, Ltd.

### Formation of Intermediate Layer and Cover

Next, using the resin material formulations shown in Table 2 below, an intermediate layer and a cover were successively injection-molded over the core obtained as described above, thereby producing a golf ball. At this time, dimples were formed in a common arrangement on the cover surface in each of the Working Examples and Comparative Examples. In Comparative Example 3, an intermediate layer was not formed; only a cover was formed. Also, “Resin c” in the table indicates the resin material used in the inner core layer of Comparative Example 2.

TABLE 2

| Resin material (pbw) | Resin a | Resin b | Resin c | Resin d |
|---|---|---|---|---|
| AM7315 | 50 | | | |
| AD8546 | 50 | | | |
| Himilan 1706 | | | | 50 |
| Himilan 1601 | | | | 50 |
| T-8290 | | 75 | | |
| T-8283 | | 25 | | |
| Hytrel 4001 | | 11 | | |
| Hytrel 3046 | | | 100 | |
| Titanium oxide | | 3.9 | | |
| Polyethylene wax | | 1.2 | | |
| Isocyanate compound | | 7.5 | | |

Trade names for the chief materials shown in Table 2 are as follows.
AM7315: An ionomer (acid content, 20 wt %) from DuPont-Mitsui Polychemicals Co., Ltd.
AD8546: An ionomer (acid content, 19 wt %) from E.I. DuPont de Nemours & Co.
Himilan ® 1706, Himilan ® 1601: Ionomers available from DuPont-Mitsui Polychemicals Co., Ltd.
T-8290, T-8283: Ether-type thermoplastic polyurethanes available from DIC Bayer Polymer under the trade name “Pandex”
Hytrel ® 4001, Hytrel ® 3046: Polyester elastomers available from DuPont-Toray Co., Ltd.
Polyethylene wax: Available under the trade name “Sanwax 161P” from Sanyo Chemical Industries, Ltd.
Isocyanate compound: 4,4′-Diphenylmethane diisocyanate

For each of the golf balls thus obtained, properties such as the center hardness of the inner core layer, the surface hardnesses of the inner and outer core layers, the diameters of the inner core layer, the entire core, the intermediate layer-encased sphere and the ball, the thicknesses and material hardnesses of the respective layers, and the surface hardnesses and deformations under given loading (deflection) of the respective spheres were evaluated by the following methods. The results are shown in Table 3.

### Diameter of Inner Core Layer, Outer Core Layer, and Intermediate Layer-Encased Sphere

The diameters at five random places on the surface were measured at a temperature of 23.9±1° C. and, using the average of these measurements as the measured value for a single inner core layer, entire core (that is, the inner and outer core layers combined) or intermediate layer-encased sphere, the average diameter for five measured specimens of each was determined.

### Ball Diameter

The diameters at five random dimple-free areas on the surface of a ball were measured at a temperature of 23.9±1° C. and, using the average of these measurements as the measured value for a single ball, the average diameter for five measured balls was determined.

### Deflection of Inner Core Layer, Core (Outer Core Layer-Encased Sphere), Intermediate Layer-Encased Sphere and Ball

An inner core layer, entire core, intermediate layer-encased sphere or ball was placed on a hard plate and the amount of deflection when compressed under a final load of 1,275 N (130 kgf) from an initial load of 98 N (10 kgf) was measured. The amount of deflection refers in each case to the measured value obtained after holding the test specimen isothermally at 23.9° C.

### Center Hardness of Inner Core Layer and Surface Hardnesses of Inner Core Layer and Outer Core Layer (JIS-C Scale)

The center hardness of the inner core layer was obtained by cutting the inner core layer in half through the center and measuring the hardness at the center of the resulting cross-section. The respective surface hardnesses of the inner core layer and the outer core layer were obtained by perpendicularly pressing the indenter of a durometer against the surface of the spherical inner core layer or the entire core and measuring the hardness. All of these hardnesses were measured with the spring-type durometer (JIS-C model) specified in JIS K 6301-1975. Shore D hardness measurements were carried out using a type D durometer in accordance with ASTM D2240-95.

### Surface Hardnesses of Intermediate Layer-Encased Sphere and Ball (Shore D Scale)

Measurements were taken by pressing the durometer indenter perpendicularly against the surface of the intermediate layer-encased sphere or the ball (cover). The surface hardness of the ball (cover) is the measured value obtained at dimple-free places (lands) on the ball surface. The Shore D hardnesses were measured with a type D durometer in accordance with ASTM D2240-95.

### Material Hardnesses of Intermediate Layer and Cover (Shore D Hardness)

The intermediate layer-forming resin material and cover-forming resin materials were molded into sheets having a thickness of 2 mm and left to stand for at least two weeks, following which the Shore D hardnesses were measured with a type D durometer in accordance with ASTM D2240-95. These hardnesses are denoted in the table as the “Sheet material hardness.”

TABLE 3

| | | Working Example | | | | Comparative Example | | | | | |
|---|---|---|---|---|---|---|---|---|---|---|---|
| | | 1 | 2 | 3 | 4 | 1 | 2 | 3 | 4 | 5 | 6 |
| Inner core layer | Material | No. 1 | No. 1 | No. 12 | No. 12 | No. 2 | Resin c | No. 1 | No. 1 | No. 3 | No. 10 |
| | Diameter (mm) | 23.1 | 23.1 | 23.1 | 23.1 | 38.7 | 23.1 | 23.1 | 23.1 | 23.1 | 35.2 |
| | Weight (g) | 7.4 | 7.4 | 7.4 | 7.4 | 34.9 | 6.9 | 7.4 | 7.4 | 7.4 | 26.4 |
| | Specific gravity (g/cm³) | 1.15 | 1.15 | 1.15 | 1.15 | 1.15 | 1.07 | 1.15 | 1.15 | 1.11 | 1.15 |
| | Deflection (mm) | 7.4 | 7.4 | 7.4 | 7.4 | 3.9 | 7.5 | 7.4 | 7.4 | 7.4 | 4.3 |
| | Surface hardness (Cs), JIS-C | 75 | 75 | 75 | 75 | 83 | 52 | 75 | 75 | 75 | 82 |
| | Center hardness (Cc), JIS-C | 49 | 49 | 49 | 49 | 56 | 44 | 49 | 49 | 49 | 53 |
| | Surface hardness − Center hardness (Cs − Cs), JIS-C | 26 | 26 | 26 | 26 | 27 | 8 | 26 | 26 | 26 | 29 |
| | Surface hardness (Shore D) | 49 | 49 | 49 | 49 | 55 | 32 | 49 | 49 | 49 | 54 |
| Outer core layer | Material | No. 4 | No. 13 | No. 14 | No. 15 | None | No. 5 | No. 6 | No. 4 | No. 7 | No. 11 |
| (including inner core layer) | Diameter (mm) | 38.65 | 38.65 | 38.65 | 38.65 | | 38.65 | 41.05 | 38.65 | 38.65 | 38.70 |
| | Thickness (outer core layer only) (mm) | 7.8 | 7.8 | 7.8 | 7.8 | | 7.8 | 9.0 | 7.8 | 7.8 | 1.8 |
| | Weight (including inner core layer) (g) | 34.9 | 34.9 | 34.9 | 34.9 | | 34.9 | 40.6 | 34.9 | 33.6 | 35.0 |
| | Specific gravity (outer core layer only) (g/cm³) | 1.15 | 1.15 | 1.15 | 1.15 | | 1.18 | 1.11 | 1.15 | 1.11 | 1.15 |
| | Deflection (including inner core layer) (mm) | 3.5 | 3.9 | 3.5 | 3.9 | | 3.6 | 3.3 | 3.5 | 3.5 | 3.6 |
| | Surface hardness (Css), JIS-C | 88 | 85 | 88 | 85 | | 88 | 90 | 88 | 88 | 91 |
| | Surface hardness − Center hardness (Css − Cc), JIS-C | 39 | 36 | 39 | 36 | | 44 | 41 | 39 | 39 | 38 |
| | Surface hardness (Shore D) | 59 | 57 | 59 | 57 | | 59 | 60 | 59 | 59 | 61 |
| Intermediate | Material | Resin a | Resin a | Resin a | Resin a | Resin a | Resin a | None | Resin d | Resin b | Resin a |
| layer | Thickness (mm) | 1.20 | 1.20 | 1.20 | 1.20 | 1.20 | 1.20 | | 1.20 | 0.83 | 1.18 |
| | Specific gravity (g/cm³) | 0.95 | 0.95 | 0.95 | 0.95 | 0.95 | 0.95 | | 0.95 | 1.15 | 0.95 |
| | Sheet material hardness (Shore D) | 66 | 66 | 66 | 66 | 66 | 66 | | 61 | 47 | 66 |
| Intermediate layer- | Diameter (mm) | 41.05 | 41.05 | 41.05 | 41.05 | 41.05 | 41.05 | | 41.05 | 40.30 | 41.05 |
| encased sphere | Weight (g) | 40.6 | 40.6 | 40.6 | 40.6 | 40.6 | 40.6 | | 40.6 | 38.3 | 40.6 |
| | Deflection (mm) | 2.8 | 3.1 | 2.8 | 3.1 | 3.1 | 2.8 | | 3.0 | 3.2 | 2.8 |
| | Surface hardness (Shore D) | 72 | 72 | 72 | 72 | 72 | 72 | | 67 | 53 | 72 |
| Intermediate layer surface hardness − | | 13 | 15 | 13 | 15 | — | 13 | — | 8 | −6 | 11 |
| Core surface hardness (Shore D) | | | | | | | | | | | |
| Outer core layer deflection − | | 0.7 | 0.7 | 0.4 | 0.7 | — | 0.8 | — | 0.5 | 0.3 | 0.8 |
| Intermediate layer-encased sphere deflection | | | | | | | | | | | |
| Cover | Material | Resin b | Resin b | Resin b | Resin b | Resin b | Resin b | Resin b | Resin b | Resin a | Resin b |
| | Thickness (mm) | 0.83 | 0.83 | 0.83 | 0.83 | 0.83 | 0.83 | 0.83 | 0.83 | 1.2 | 0.83 |
| | Specific gravity (g/cm³) | 1.15 | 1.15 | 1.15 | 1.15 | 1.15 | 1.15 | 1.15 | 1.15 | 0.98 | 1.15 |
| | Sheet material hardness (Shore D) | 47 | 47 | 47 | 47 | 47 | 47 | 47 | 47 | 66 | 47 |
| Ball | Diameter (mm) | 42.7 | 42.7 | 42.7 | 42.7 | 42.7 | 42.7 | 42.7 | 42.7 | 42.7 | 42.7 |
| | Weight (g) | 45.5 | 45.5 | 45.5 | 45.5 | 45.5 | 45.5 | 45.5 | 45.5 | 45.5 | 45.5 |
| | Deflection (mm) | 2.6 | 2.9 | 2.6 | 2.9 | 2.9 | 2.6 | 2.9 | 2.8 | 2.6 | 2.6 |
| | Surface hardness (Shore D) | 59 | 59 | 59 | 59 | 59 | 59 | 57 | 58 | 72 | 59 |

| | | | | | | | | | | |
|---|---|---|---|---|---|---|---|---|---|---|
| Surface hardness of inner core layer − | −10 | −10 | −10 | −10 | −4 | −27 | −8 | −9 | −23 | −5 |
| Surface hardness of ball (Shore D) | | | | | | | | | | |
| Surface hardness of ball − | −13 | −13 | −13 | −13 | −13 | −13 | — | −9 | 19 | −13 |
| Surface hardness of intermediate layer (Shore D) | | | | | | | | | | |
| Intermediate layer thickness − Cover thickness (mm) | 0.38 | 0.38 | 0.38 | 0.38 | 0.38 | 0.38 | — | 0.38 | −0.37 | 0.35 |
| Inner core layer deflection − Ball deflection (mm) | 4.8 | 4.5 | 4.8 | 4.5 | 1.0 | 4.9 | 4.5 | 4.6 | 4.8 | 1.7 |
| (Inner core layer deflection)/(Outer core layer | 2.1 | 1.9 | 2.1 | 1.9 | — | 2.1 | 2.2 | 2.1 | 2.1 | 1.2 |
| deflection) | | | | | | | | | | |
| (Inner core layer deflection)/(Intermediate layer- | 2.6 | 2.4 | 2.6 | 2.4 | 1.3 | 2.7 | — | 2.5 | 2.3 | 1.5 |
| encased sphere deflection) | | | | | | | | | | |
| (Inner core layer deflection)/(Ball deflection) | 2.8 | 2.6 | 2.8 | 2.6 | 1.3 | 2.9 | 2.6 | 2.6 | 2.8 | 1.7 |

The flight performance, spin performance on approach shots, and durability on repeated impact of each of the golf balls were evaluated as described below. The results are present in Table 4. All measurements were carried out in a 23° C. environment.

### Flight Performance

A driver (W#1) was mounted on a golf swing robot, the distance traveled by the ball when struck at a head speed (HS) of 45 m/s was measured, and the flight performance was rated according to the criteria shown below. The club used was the TourStage X-Drive 709 D430 driver (2013 model; loft angle,)9.5°) manufactured by Bridgestone Sports Co., Ltd. The spin rate of the ball immediately after being struck was measured with an apparatus for measuring the initial conditions.

Rating Criteria:
Good: Total distance was 230.0 m or more
NG: Total distance was less than 230.0 m

### Spin Performance on Approach Shots

A sand wedge (SW) was mounted on a golf swing robot, and the spin rate immediately after striking the ball at a head speed of 20 m/s was measured with an apparatus for measuring the initial conditions. The spin performance was rated according to the criteria shown below.

Rating criteria:
Good: Spin rate was 5,700 rpm or more
NG: Spin rate was less than 5,700 rpm

### Durability on Repeated Impact

The balls in the respective Examples were repeatedly struck at a head speed (HS) of 40 m/s with the same driver (W#1) as that mentioned above mounted on a golf swing robot. The durability index in each Example was calculated relative to an arbitrary index of 100 for the number of shots at which the initial velocity of the ball in Example 2 fell to or below 97% of the average initial velocity for the first 10 shots. The durability used in each Example was an average value for three sample balls.
Good: Durability index was 90 or more
NG: Durability index was less than 90

The core productivity in each Example was evaluated according to the following criteria. The results are presented in Table 4.

### Productivity

During mixing and extrusion of the rubber composition, the following were evaluated: (i) mixing time, (ii) sticking to inner wall of mixing apparatus, (iii) residue, (iv) coherence of rubber composition following mixture, and (v) surface roughness of rubber composition when extruded. These were judged collectively as being indicative of very high productivity (Exc), high productivity (Good), or low productivity (NG). The respective productivities for the inner core layer and the outer core layer were evaluated; the evaluation results for the overall core are presented in Table 4. In Comparative Example 1, the core has a single layer, and so the rubber composition for this single-layer core was evaluated. In Comparative Example 2, the inner core layer is made of a resin material, and so the above evaluation was carried out on the rubber composition for the outer core layer.

TABLE 4

| | | | Working Example | | | | Comparative Example | | | | | |
|---|---|---|---|---|---|---|---|---|---|---|---|---|
| | | | 1 | 2 | 3 | 4 | 1 | 2 | 3 | 4 | 5 | 6 |
| Core productivity (processability) | | | good | good | Exc | Exc | good | good | good | good | good | good |
| Flight | W#1 | Spin rate | 3,076 | 2,968 | 3,066 | 2,965 | 3,036 | 3,088 | 3,122 | 3,116 | 3,046 | 3,129 |
| performance | (HS, | (rpm) | | | | | | | | | | |
| | 45 m/s) | Total | 230.7 | 232.3 | 230.9 | 232.4 | 229.1 | 230.5 | 228.3 | 229.2 | 230.4 | 229.6 |
| | | distance (m) | | | | | | | | | | |
| | | Rating | good | good | good | good | NG | good | NG | NG | good | NG |

| | | | | | | | | | | | |
|---|---|---|---|---|---|---|---|---|---|---|---|
| Spin performance on | Spin rate | 6,277 | 6,067 | 6,266 | 6,063 | 6,075 | 6,285 | 6,265 | 6,088 | 4,214 | 6,254 |
| approach shots | (rpm) | | | | | | | | | | |
| | Rating | good | good | good | good | good | good | good | good | NG | good |
| Durability to repeated | Rating | good | good | good | good | good | NG | good | good | good | good |
| impact | | | | | | | | | | | |

As demonstrated by the results in Table 4, the golf balls of Comparative Examples 1 to 6 were inferior in the following ways to the golf balls obtained in the Working Examples according to the invention.

The golf ball in Comparative Example 1 has a single-layer core. The spin rate-lowering effect on full shots with a driver (W#1) was inadequate, and the initial velocity of the ball when hit did not increase. As a result, the intended distance was not obtained on shots with a driver.

In the golf ball in Comparative Example 2, the inner core layer is formed of a polyester material and adherence between the rubber outer core layer and the inner core layer made of this resin is weak. As a result, the durability on repeated impact was poor.

The golf ball in Comparative Example 3 is a three-piece solid golf ball that has a two-layer core and a single outer layer (cover), but does not have a hard intermediate layer. The spin rate-lowering effect on full shots with a driver (W#1) was inadequate, as a result of which the intended distance was not obtained.

In Comparative Example 4, the intermediate layer has a hardness on the Shore D scale of less than 66 and thus is relatively soft. The spin rate-lowering effect on full shots with a driver (W#1) was inadequate, as a result of which the intended distance was not obtained.

Comparative Example 5 is a four-piece solid golf ball having a two-layer core and two outer layers (intermediate layer and cover), wherein the cover-encased sphere (i.e., the ball) has a higher surface hardness than the intermediate layer-encased sphere. As a result, the spin performance in the short game was completely inadequate.

Comparative Example 6 is a four-piece solid golf ball having a two-layer core and two outer layers (intermediate layer and cover), wherein the inner core layer has a larger diameter and the outer core layer is thinly formed. This golf ball had an inadequate spin rate-lowering effect on full shots, as a result of which the intended distance was not achieved on shots with a driver.

Japanese Patent Application No. 2016-235110 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A multi-piece solid golf ball comprising:
a two-layer core comprised of an inner core layer and an outer core layer,
a cover, and
at least one intermediate layer between the core and the cover, wherein the inner core layer and the outer core layer are formed of different rubber compositions, the intermediate layer and the cover are formed of different resin compositions, the inner core layer has a diameter of not more than 35.0 mm, the value obtained by subtracting the JIS-C hardness at the center of the inner core layer (Cc) from the JIS-C hardness at the surface of the outer core layer (Css) is at least 25, the intermediate layer has a material hardness measured on the Shore D scale of at least 65, and the intermediate layer-encased sphere, defined as the sphere obtained by encasing the core with the intermediate layer, has a higher surface hardness than the cover-encased sphere, defined as the sphere obtained by encasing the core and intermediate layer with the cover.

2. The golf ball of claim 1, wherein the resin composition of the intermediate layer includes at least 50 wt % of an ionomer having an acid content of at least 16 wt %.

3. The golf ball of claim 1, wherein the material hardness of the intermediate layer on the Shore D scale is from 65 to 74.

4. The golf ball of claim 1, wherein the rubber composition of the inner core layer includes water.

5. The golf ball of claim 1, wherein the value obtained by subtracting the JIS-C hardness at the center of the inner core layer (Cc) from the JIS-C hardness at the surface of the inner core layer (Cs) is at least 22.

6. The golf ball of claim 1, wherein the value obtained by subtracting the JIS-C hardness at the center of the inner core layer (Cc) from the JIS-C hardness at the surface of the outer core layer (Css) is not more than 45.

7. The golf ball of claim 1, wherein the core is formed of a rubber composition comprising:
(i) a base rubber,
(ii) an α,β-unsaturated carboxylic acid and/or a metal salt thereof,
(iii) a crosslinking initiator, and
(iv) a metal carboxylate in which the carboxylic acid bonded to metal is of two or more different types and at least one of the carboxylic acids has 8 or more carbon atoms.
